(19) United States
(12) Patent Application Publication
(10) Pub. No.: US 2008/0301555 A1
(43) Pub. Date: Dec. 4, 2008

(54) SYSTEM AND METHOD FOR PROVIDING ANIMATED BROWSER THUMBNAILS

(75) Inventors: Elina Vartiainen, Helsinki (FI); Jarmo Kauko, Tampere (FI); Janne Kaasalainen, Helsinki (FI); Andrei Popescu, London (GB)

Correspondence Address: FOLEY & LARDNER LLP, P.O. BOX 80278, SAN DIEGO, CA, 92138-0278, US

(73) Assignee: Nokia Corporation

(21) Appl. No.: 11/755,689

(22) Filed: May 30, 2007

(51) Int. Cl. G06F 3/00

(52) U.S. Cl. 715/704

(57) ABSTRACT

A system and method for providing animated browser thumbnails for use in a browser. The actions of a user on a particular web page can be recorded and saved by the system as a bookmark and/or other historical item in the browser's browsing history. When the user later decides to scroll through saved bookmarks and/or the browsing history, the browser exhibits the thumbnail to the user in an animated form, playing the user's prior actions back to the user.

### FIELD OF THE INVENTION

The present invention relates generally to the viewing and navigation of digital visual content through web browsers. More particularly, the present invention relates to the viewing of digital content through web browsers running on small screen devices.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Many browsers currently possess bookmarks and history systems that comprise a graphical list control. In such graphical list controls, each item typically comprises either a text string or a static image. Text strings usually comprise a title or description for the web page at issue, while static images can comprise an actual image of the web page. For example, the S60 browser, developed by Nokia Corporation, includes a “Visual History” function which provides static images of prior web pages visited by the user. In the S60 browser, the browser history is rendered as a graphical list of Web page thumbnails. FIG. 1 shows the rendering of such a Visual History on a display 32 of a device. In the visual history, a viewed thumbnail 110 is brought to the foreground for easier viewing by the user, while previous thumbnails 120 and subsequent thumbnails 130 remain in the background.

However, a potential problem with both text strings and static images involves the possibility that the text string or static image may not be sufficiently descriptive for a user to understand what is being referenced. In the case of a text string, the saving of a bookmark may require the user to type a new name if the default name is not appropriate and/or sufficiently descriptive to be understandable to the user. Furthermore, although browsers often use the title of the page being bookmarked as a default name, many pages do not explicitly define a title. In the case of static images, several identical images may appear in a Visual History or similar lists maintained by the browser, making it virtually impossible for a user to differentiate the images. This is further complicated by the fact that the viewing and distinguishing of any web content on electronic devices can be difficult because of the small size of the screen on most mobile devices.

It would therefore be desirable to provide an improved system for identifying items such as bookmarks and histories of web pages in browsing systems.

### SUMMARY OF THE INVENTION

Various embodiments of the present invention provide a system and method for providing animated browser thumbnails for use as bookmarks and/or other historical items in a browser. According to various embodiments, the actions of a user on a particular web page can be recorded and saved by the system as a bookmark and/or other historical item in the browser's browsing history. When the user later decides to scroll through saved bookmarks and/or the browsing history, the browser exhibits the thumbnail to the user in an animated form, playing the user's prior actions back to the user. With such animated representations, more information is provided to a user in bookmarks and/or the browser's browsing history than in previous systems, making references and/or archived web pages easier to recognize by the user.

Various embodiments provide, a method, computer program product, and apparatus for providing web page information in an animated form through a browser. In these embodiments, an animation of a web page is, the animation reflecting actions taken by a user when visiting the web page. In response to an attempt to obtain information about the web page at a subsequent time, the animation as a thumbnail and the animation is run. Various embodiments also provide an apparatus for providing web page information in animated form, comprising means for creating an animation of a web page, the animation reflecting actions taken by a user when visiting the web page; means for, in response to an attempt to obtain information about the web page at a subsequent time, exhibiting the animation as a thumbnail; and means for running the animation.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a Visual History being used on a conventional S60 browser;

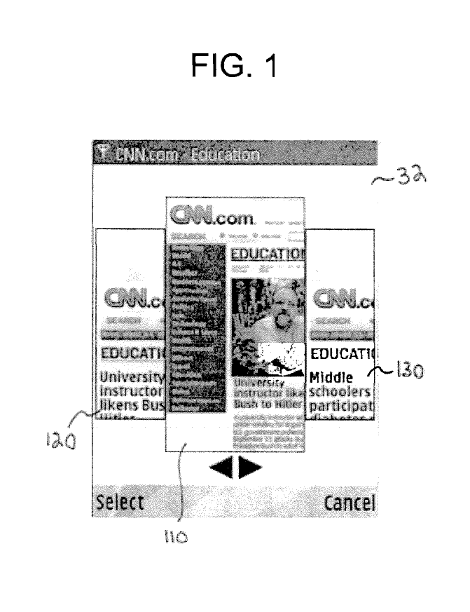

FIG. 2 is a representation of the initial rendering of an animated thumbnail image on a browser according to various embodiments of the present invention;

FIG. 3 shows the animated thumbnail image of FIG. 2 in a second position;

FIG. 4 shows the animated thumbnail image of FIG. 2 in a third position;

FIG. 5 shows the animated thumbnail image of FIG. 2 in a fourth position;

FIG. 6 is a flow chart showing how an animated thumbnail image can be saved, retrieved and used according to various embodiments of the present invention;

FIG. 7 is a perspective view of a mobile telephone that can be used in the implementation of the present invention; and

FIG. 8 is a schematic representation of the telephone circuitry of the mobile telephone of FIG. 7.

### DETAILED DESCRIPTION OF VARIOUS EMBODIMENTS

Various embodiments of the present invention provide a system and method for providing animated browser thumbnails for use as bookmarks and/or other historical items in a browser. The actions of a user on a particular web page can be recorded and saved by the system as a bookmark and/or other historical item in the browser's browsing history. When the user later decides to scroll through saved bookmarks and/or the browsing history, the browser exhibits the thumbnail to the user in an animated form, playing the user's prior actions back to the user.

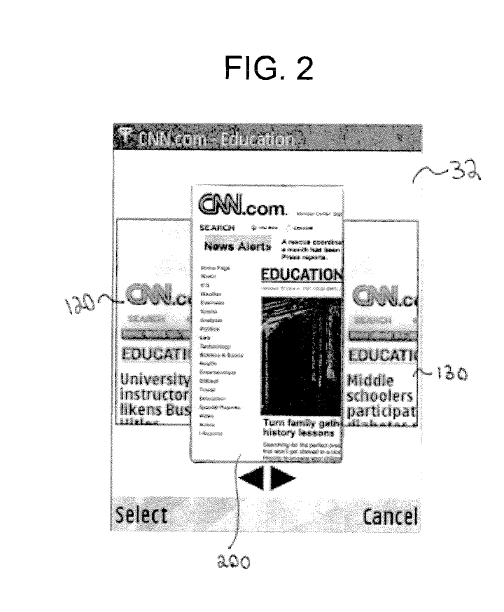

FIGS. 2-5 show how an animated thumbnail 200 can be exhibited to a user according to various embodiments of the present invention. It should be noted that, although FIGS. 2-5 show the animated thumbnail 200 in the context of a Visual History system of the S60 browser, the animated thumbnail 200 shown therein would also appear in substantially the same format when saved as a bookmark according to various embodiments of the present invention, as well as in other implementations.

As shown in FIGS. 2-5, the display 32 of an electronic device shows the animated thumbnail 200 in the foreground, in front of previous thumbnails 120 and subsequent thumbnails 130. In accordance with the various embodiments, the animated thumbnail 200 is previously saved to reflect actions taken by the user when he or she previously visited the relevant page. For example, if the user initially starts with the upper left hand corner of the web page at issue, then scrolls down the left side of the page, then moves to the right side, the system can capture a set of frames to create an animated file (for example, bitmap graphics files such as an animated. GIF files, scalable vector graphics files such as flash files, or files of some other format). When a user later returns to this web page in the Visual History, the saved file is played as the animated thumbnail 200 on the display 32, showing precisely how the user navigated around the web page during the prior visit.

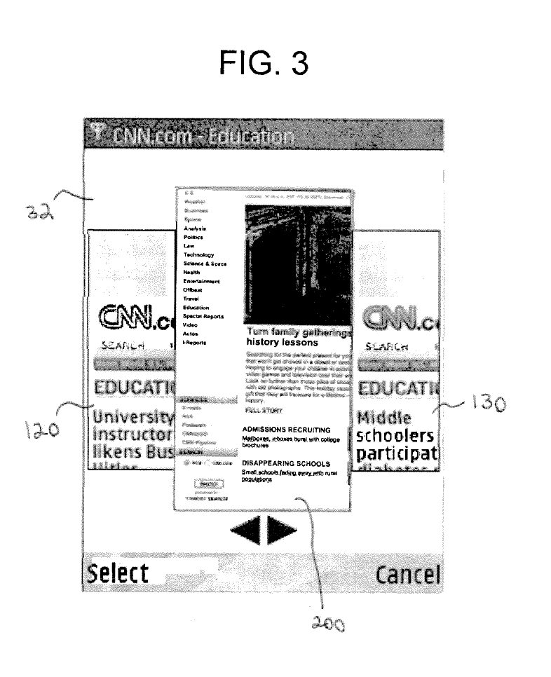

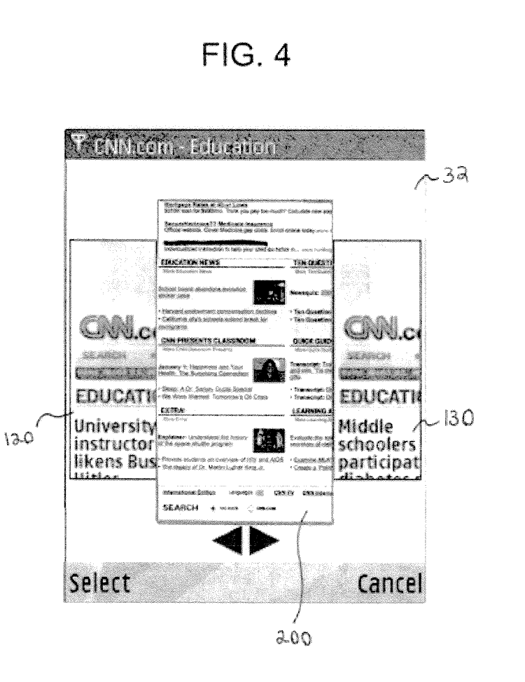

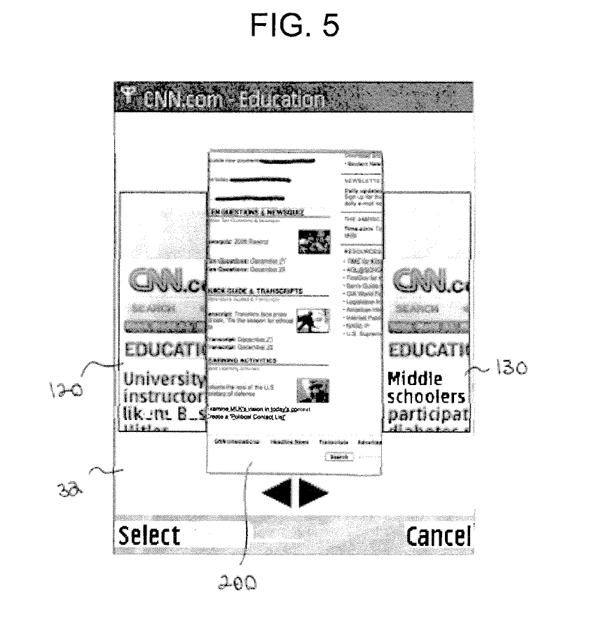

FIGS. 2-5 show the animation of the animated thumbnail 200 in the example discussed above. In FIG. 2, the animated thumbnail 200 shows the portion of the web page as it initially appeared when first accessed by the user, beginning with the upper left-hand corner of the web page (this can be a default setting in one embodiment of the invention). FIGS. 3 and 4 show how the user initially moved down the left-hand side of the web page, with FIG. 3 showing the middle-left of the page and FIG. 4 showing the lower left-hand corner. FIG. 5 shows still further actions taken by the user, more particularly showing how the user moved along the bottom of the page from left to right. By providing a more comprehensive “scan” of the web page, the animated thumbnail 200 provides the user with more information and helps to address the issue of a history list/Visual History containing several nearly identical-looking thumbnails.

As mentioned above, a variety of user interface elements/systems can make use of animated thumbnails 200 in addition to a history list/Visual History system. One such system involves using animated thumbnails 200 as browser bookmarks. For example, the typical list of bookmarks can be replaced with a grid of animated thumbnails 200. Alternatively, when a user focuses on an item in the bookmarks list, a representative animated thumbnail 200 of the page can be shown as a preview of the actual page. As a further extension, if a user were to send a bookmark of a web page to another person's device, a corresponding animated thumbnail 200 may also be attached.

Another use for animated thumbnails 200 is in the context of managing saved pages. In this scenario, animated thumbnails 200 can be exhibited to a user whenever a user views a set of previously saved pages, once again enabling the differentiation of many similarly-appearing pages.

In addition to the above, animated thumbnails 200 can be used to store state information about the web pages which the animated thumbnails represent. For example, if animated thumbnails 200 are implemented as part of a bookmark system, each animated thumbnail 200 can highlight portions of the page that have changed since the last time that the user visited the page. The highlighting of changed portions can be implemented, for example, by automatically fetching the page on a regular basis, determining what (if any) changes have occurred and re-rendering the page. The areas that have new content can be highlighted by applying any of a variety of special graphical effects, including traditional highlighting, glowing, underlining, etc.

In yet another embodiment, the state of a generated “minimap” can be used to generate the frames that are used to create the animated thumbnails 200. A minimap is a transparent overview of content which is displayed in conjunction with the content itself. Minimaps are discussed in detail in U.S. Patent Publication No. 2006/0123183, assigned to Nokia Corporation. In many instances, a minimap will highlight or otherwise designate the portion of the web page that is being primarily exhibited to the user, and this designated region can be used for the appropriate frame capture and creation of the animated thumbnail 200 for the web page.

The actual playing of animated thumbnails 200 can take a variety of forms. In one embodiment, each animated thumbnail 200 can play whenever accessed or viewed. In another embodiment, on the other hand, an additional affirmative action is required by the user. For example, in the Visual History system depicted in FIGS. 2-5, the animated thumbnail 200 can remain in its “starting” position shown in FIG. 2 unless the user actuates the thumbnail, for example by right-clicking on the thumbnail and selecting a “play” option. This implementation may be particularly useful in mobile devices with relatively low processing capabilities, where the automatic playing of each thumbnail when access could hinder the performance of various features on the device. On the other hand, automatically playing the animated thumbnail 200 saves the user from having to perform additional actions to view the animated thumbnail 200 in its entirety. In yet another embodiment, the playing of the animated thumbnail can begin a specified period of time, e.g., five seconds, after the animated thumbnail 200 is accessed or after some other action by the user. In certain embodiments, the specified amount of time can be set and/or modified by the user.

In still another embodiment, it is also possible to have an animated thumbnail 200 provided to the user without the user even having to visit the web page at issue. In particular, it is possible for the user to direct the browser application at issue to view the web page and provide the user with an animated thumbnail without the user access the page itself. In this situation, a user can, for example, click on a hyperlink for a web page and, instead of choosing to view the page, the user can instruct the browser to retrieve an overview of the page to provide to the user as part of an animated thumbnail 200. Alternatively, the user may only need to allow the cursor to hover over a hyperlink in order for the above process to implemented. Other variations of these various implementations are also possible.

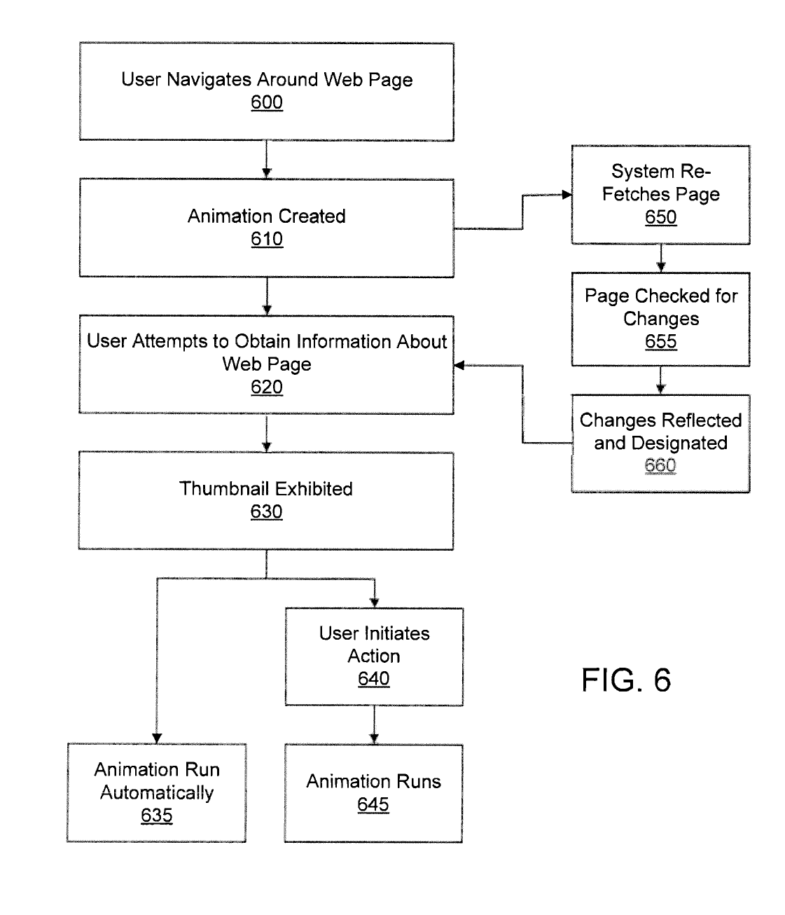

FIG. 6 is a flow chart showing the implementation of various embodiments of the present invention. At 600 in FIG. 6, a user visits a web page and navigates around the page. The system, having monitored the user's navigation, records and saves a plurality of images demonstrating the user's activity and creates an animation file at 610. At a later time, the user attempts to obtain information about the page, either through checking bookmarks, accessing a viewing history, accessing saved web pages, or through some other method. Each of these possibilities is collectively identified at 620. In response to this action, the first frame of the animated thumbnail 200 is exhibited to the user at 630. In one embodiment, the animated thumbnail 200 is automatically run/played to the user at 635 immediately upon the initial exhibition. In another embodiment, the animation begins at 645 only after the user takes some initiation action at 640, such as entering a “play” command. As discussed above, another embodiment involves having the system automatically re-fetch the web page at some point after an initial viewing (represented at 650), determining whether changes have been made sine the previous viewing (represented at 655), and then updating the animation to reflect the changes, with the changes being appropriately designated (represented at 660).

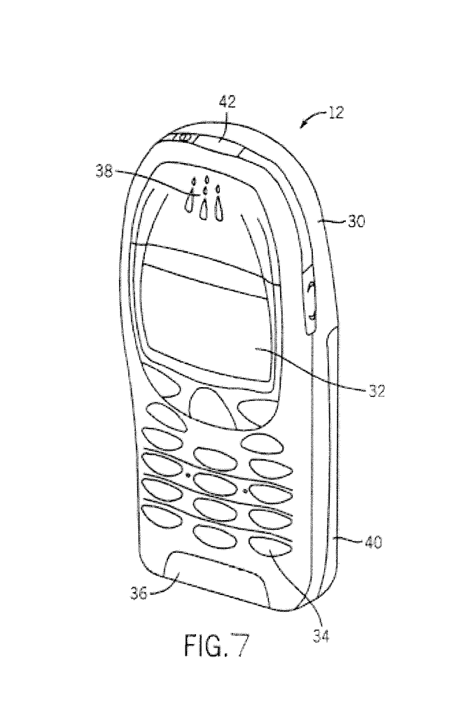

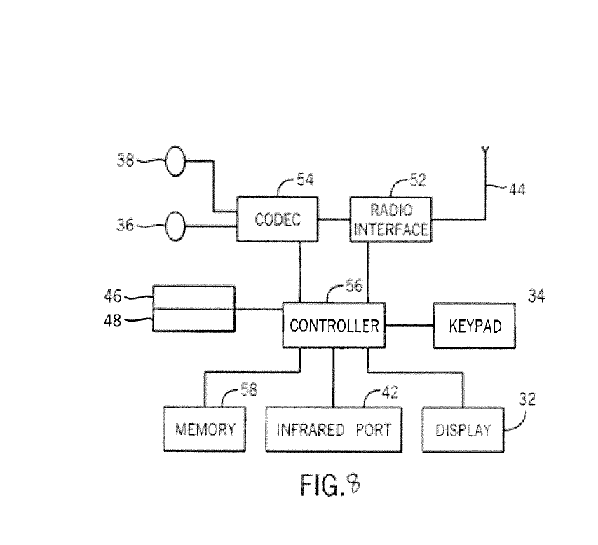

FIGS. 7 and 8 show one representative mobile telephone 12 within which the present invention may be implemented. It should be understood, however, that the present invention is not intended to be limited to one particular type of mobile telephone 12, and the various embodiments may be implemented on both mobile and nonmobile electronic devices. Exemplary communication devices may also include, but are not limited to, a combination PDA and mobile telephone, a PDA 16, an integrated messaging device (IMD) and a notebook computer. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Such devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802. 11, etc. Such devices may communicate using various media including, but not limited to, radio, infrared, laser, cable connection, etc.

The mobile telephone 12 of FIGS. 7 and 8 includes a housing 30, the display 32 in the form of a liquid crystal display in an exemplary embodiment, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing web page information in an animated form through a browser, comprising:
creating an animation of a web page, the animation reflecting actions taken by a user when visiting the web page;
in response to an attempt to obtain information about the web page at a subsequent time, exhibiting the animation as a thumbnail; and
running the animation.

2. The method of claim 1, wherein the animation is run automatically upon exhibition.

3. The method of claim 1, wherein the animation is run in response to the receipt of a “play” request.

4. The method of claim 1, wherein the attempt to obtain information comprises the accessing of a bookmark for the web page.

5. The method of claim 1, wherein the attempt to obtain information comprises the viewing of the web page within a Visual History.

6. The method of claim 1, further comprising:
after creating the animation, revisiting the web page;
identifying changes in the web page that have occurred since the user visited the web page; and
updating the animation to reflect the identified changes to the web page.

7. The method of claim 6, wherein the updating of the animation includes designating the identified changes in the web page.

8. The method of claim 1, wherein the creating of the animation includes generating an animation file from a plurality of captured frames of the web page reflecting the user's actions.

9. The method of claim 8, wherein the animation file comprises a .gif file.

10. The method of claim 1, wherein the actions of the user comprise a viewing path taken by the user through the web page during the user's visiting.

11. A computer program product, embodied in a computer-readable medium, for providing web page information in an animated form through a browser, comprising:
computer code for creating an animation of a web page, the animation reflecting actions taken by a user when visiting the web page;
computer code for, in response to an attempt to obtain information about the web page at a subsequent time, exhibiting the animation as a thumbnail; and
computer code for running the animation.

12. The computer program product of claim 11, wherein the animation is run in response to the receipt of a “play” request.

13. The computer program product of claim 11, wherein the attempt to obtain information comprises the accessing of a bookmark for the web page.

14. The computer program product of claim 11, wherein the attempt to obtain information comprises the viewing of the web page within a Visual History.

15. The computer program product of claim 11, further comprising:
computer code for, after creating the animation, revisiting the web page;
computer code for identifying changes in the web page that have occurred since the user visited the web page; and
computer code for updating the animation to reflect the identified changes to the web page.

16. The computer program product of claim 15, wherein the updating of the animation includes designating the identified changes in the web page.

17. The computer program product of claim 11, wherein the actions of the user comprise a viewing path taken by the user through the web page during the user's visiting.

18. An apparatus, comprising:
a processor; and
a memory unit communicatively connected to the processor and including:
computer code for creating an animation of a web page, the animation reflecting actions taken by a user when visiting the web page;
computer code for, in response to an attempt to obtain information about the web page at a subsequent time, exhibiting the animation as a thumbnail; and
computer code for running the animation.

19. The apparatus of claim 18, wherein the animation is run automatically upon exhibition.

20. The apparatus of claim 18, wherein the animation is run in response to the receipt of a “play” request.

21. The apparatus of claim 18, wherein the attempt to obtain information comprises the accessing of a bookmark for the web page.

22. The apparatus of claim 18, wherein the attempt to obtain information comprises the viewing of the web page within a Visual History.

23. The apparatus of claim 18, wherein the memory unit further comprises:
computer code for, after creating the animation, revisiting the web page;
computer code for identifying changes in the web page that have occurred since the user visited the web page; and
computer code for updating the animation to reflect the identified changes to the web page.

24. The apparatus of claim 23, wherein the updating of the animation includes designating the identified changes in the web page.

25. The apparatus of claim 18, wherein the creating of the animation includes generating an animation file from a plurality of captured frames of the web page reflecting the user's actions.

26. The apparatus of claim 25, wherein the animation file comprises a .gif file.

27. The apparatus of claim 18, wherein the actions of the user comprise a viewing path taken by the user through the web page during the user's visiting.

28. A device, comprising:
means for creating an animation of a web page, the animation reflecting actions taken by a user when visiting the web page;
means for, in response to an attempt to obtain information about the web page at a subsequent time, exhibiting the animation as a thumbnail; and
means for running the animation.

29. The device of claim 28, wherein the attempt to obtain information comprises the accessing of a bookmark for the web page.

30. The device of claim 28, wherein the attempt to obtain information comprises the viewing of the web page within a Visual History.

31. A method of providing web page information in an animated form, comprising:
in response to an attempt to obtain information about a web page, exhibiting a previously created animation as a thumbnail, the animation reflecting actions taken by a user when visiting the web page; and
running the animation.

32. The method of claim 31, wherein the attempt to obtain information comprises the accessing of a bookmark for the web page.

33. The method of claim 31, wherein the attempt to obtain information comprises the viewing of the web page within a Visual History.

34. The method of claim 31, wherein the actions of the user comprise a viewing path taken by the user through the web page during the user's visiting

35. A computer program product, embodied in a computer-readable medium, comprising computer code configured to perform the processes of claim 31.
